(19) United States
(12) Patent Application Publication
(10) Pub. No.: US 2003/0156758 A1
(43) Pub. Date: Aug. 21, 2003

(54) Image subtraction

(76) Inventors: Paul Bromiley, Manchester (GB); Neil Thacker, Manchester (GB)

Correspondence Address: NIXON & VANDERHYE, PC, 1100 N GLEBE ROAD, 8TH FLOOR, ARLINGTON, VA, 22201-4714, US

(21) Appl. No.: 10/258,142

(22) PCT Filed: Apr. 17, 2001
(86) PCT No.: PCT/GB01/01787

(30) Foreign Application Priority Data
Apr. 19, 2000 (GB) 0009668.5

(51) Int. Cl. G06K 9/68

(52) U.S. Cl. 382/219

(57) ABSTRACT

A method of generating a difference image base upon a comparison of two input images, the method comprising generating a scattergram representing correspondence between intensity values of areas in the first image and intensity values of areas in the second image, and using characteristics of the scattergram to generate a difference image in which the effect of a global change between the first and second input images is reduced.

Image subtraction is used to identify small changes between equivalent pairs of images. Image subtraction is used in a variety of applications ranging from surveillance to interpretation of medical image data [D. Murray and A Basu, Motion Tracking with an Active Camera, IEEE Trans. Pattern Analysis and Machine Intell., 16(5), 1994, 449-459; S. Rowe and A. Blake, Statistical Mosaics for Tracking, Image and Vision Computing, 14, 1996, 549-564; D. Koller, J. Weber and J. Malik, Robust Multiple Car Tracling with Occlusion Reasoning, Proc. ECCV 1994, J-O. Ekhlund (Ed), Stockholm, pp189-196, 1994; A. Baumnberg and D. Hogg, Learning Flexible Models from Image Sequences, Proc. ECCV 1994, J-O. Ekhlund (Ed), Stockholm, pp299-308, 1994].

Commonly, only a small subset of differences between images are of interest. For example, in motion analysis only those differences caused by motion are of interest. A global difference between images, for example a change of intensity, is generally not of interest when comparing images.

In order for image subtraction to be used successfully, care is taken to ensure that a resulting difference image shows only changes due to physical mechanisms of interest. This may require that image data sets are realigned or pre-processed in order to remove global differences before image subtraction is performed. Known methods of removing global differences are of limited utility.

There are considerable difficulties associated with interpreting a difference image [J. V. Hajnal, I. R. Young and G. M. Bydder, Contrast Mechanisms in Functional MRI of the Brain, Advanced MR Imaging Techniques, Ed's W. G. Bradley Jr and G. M. Bydder, Martin Dunitz Ltd London, 195-207, 1997]. A conventional method of interpreting a difference image comprises identifying regions of change using a threshold. This is directly equivalent to forming a null hypothesis test statistic, with the assumption of a single distribution for the expected level of change due only to noise which is the same across the entire image. Known methods of providing a quantitative statistical interpretation of a difference image use statistical assumptions which are not necessarily valid, and can provide unreliable results.

It is an object of the present invention to overcome or substantially mitigate at least one of the above disadvantages.

According to the invention there is provided a method of generating a difference image based upon a comparison of two input images, the method comprising generating a scattergram representing correspondence between intensity values of areas in the first image and intensity values of areas in the second image, and using characteristics of the scattergram to generate a difference image in which the effect of a global change between the first and second input images is reduced.

The term ‘global change’ is intended to mean a change which affects all or a substantial part of an image, for example a change of image intensity caused by an altered exposure time. A global change may be almost completely eliminated using the invention.

The inventors have realised that the statistical information available within the first and second images can be used to avoid having to make statistical assumptions about the images. In the difference image generation method according to the invention, the scattergram is effectively used as a model of the global changes between first and second images. This allows the effect of the global changes to be reduced, thereby providing improved identification of localised variations between the first and second images.

Preferably, a cut through the scattergram which corresponds to areas of the first or second images having a particular intensity value or range of intensity values is normalised, intensity values of a pair of corresponding areas in the first and second images are used to define coordinates of an area in the scattergram which lies within the cut, an integration is performed along the cut, the integration summing all intensity values less than the intensity value of the defined area in the scattergram, and the result of the integration is used to determine an intensity value for a corresponding area in the difference image.

This method is advantageous because it provides a statistical value for the difference image that represents the probability of that pairing of intensity values for corresponding areas in the first and second images. A low intensity value in the difference image will represent a low probability of pairing of intensity values in the first and second images (indicating a local change between the first and second images), and a high intensity value in the difference image will represent a high probability of pairing of intensity values in the first and second images (indicating no local change between the images).

The probability measure provided by the method has the same interpretation as a conventional “chi-squared probability”, except that a particular distribution does not need to be specified (i.e. it is non-parametric).

Preferably, the result of the integration is used directly as the intensity value for the corresponding pixel in the difference image.

Preferably, the difference image is combined to determine an overall difference statistic. A low value will indicate that there are well defined local changes between the first and second images, whereas a high value will indicate that there are few local changes between the first and second image.

Preferably, a threshold intensity value is defined and a new difference image is determined which shows only those areas of the difference image which have an intensity value below that threshold.

Suitably, the scattergram is generated using a pre-selected region of the first and second images in which local variations between the images are expected to be minimal.

Suitably, a ridge indicative of similarities between the first and second images is located in the scattergram.

Preferably, an intensity value of a given area in the first image or second image is used to define an intensity value on a first axis of the scattergram, a corresponding intensity value on a second axis of the scattergram is determined using the ridge, this intensity value is used to define the intensity value of an area in a new image, and the new image is subtracted from the first image or second image to generate the difference image

Preferably, the ridge is located using cubic splines.

Preferably, the cubic splines are fitted to knot points on the ridge using simplex minimisation.

Suitably, normalisation is performed along a cut in the scattergram which corresponds to areas having a single intensity value in the first image or second image, thereby providing a probability distribution, the intensity values of a pair of corresponding areas in the first and second images are used to define coordinates of an area in the scattergram, and the intensity value of a corresponding area in the difference image is determined using a function which increases as the probability decreases.

Preferably, the function is a natural logarithm.

Preferably, the intensity value of the corresponding area in the difference image is −2 times the natural logarithm of the normalised intensity of the area in the scattergram.

This method is advantageous because the intensity values of the difference image are equivalent to the square of a z-score.

Preferably, the difference image is summed to determine an overall difference statistic.

Suitably, a pair of corresponding areas in the first and second images are used to define coordinates of an area in the scattergram, the location of a nearest local maximum is determined by comparing intensity values along a cut which corresponds to areas having a single intensity value in the first image or second image, and a z-score is calculated based upon a distance between the defined area in the scattergram and the local maximum.

Preferably, the z-score is used as an intensity value in the difference image.

Preferably, the probability that an area in the difference image represents a local difference between the first and second images is determined from the square of the intensity value of that area in the difference image.

Preferably, the areas are pixels.

Preferably, the intensity values are grey level values.

Preferably, the scattergram is smoothed.

Preferably, the scattergram is smoothed using iterative tangential smoothing.

A specific embodiment of the invention will now be described, by way of example only with reference to the accompanying figures, in which:

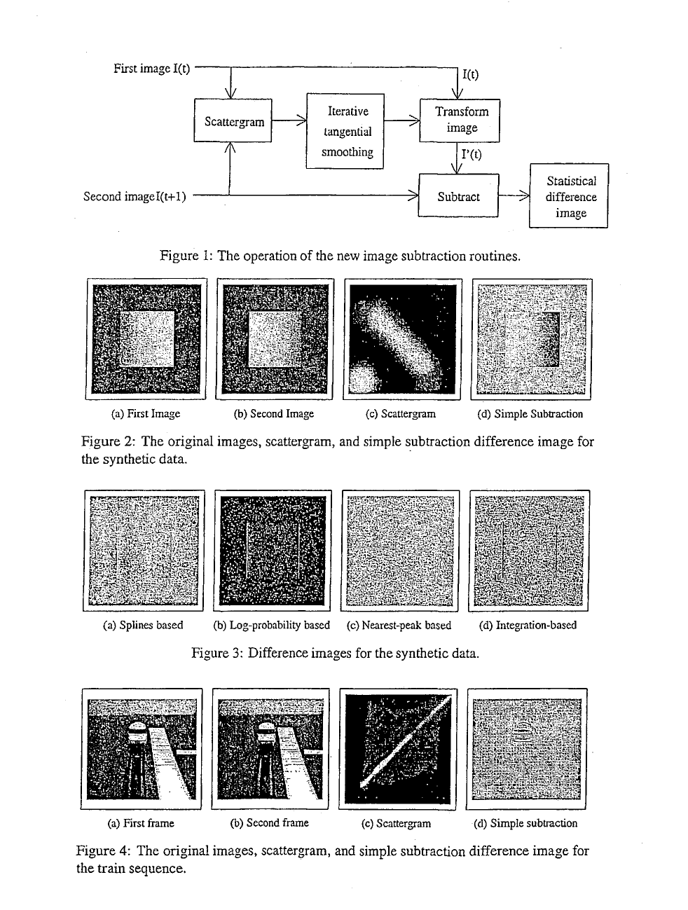

FIG. 1 is a schematic diagram of the difference image generation method according to the invention;

FIG. 2 is first and second synthetic images used to test the invention and a scattergram and difference image generated for the synthetic images, the difference image being generated by simple pixel-by-pixel subtraction;

FIG. 3 is four difference images generated using the invention for the synthetic images;

FIG. 4 is first and second images of a train, and a scattergram and difference image generated using a prior art method;

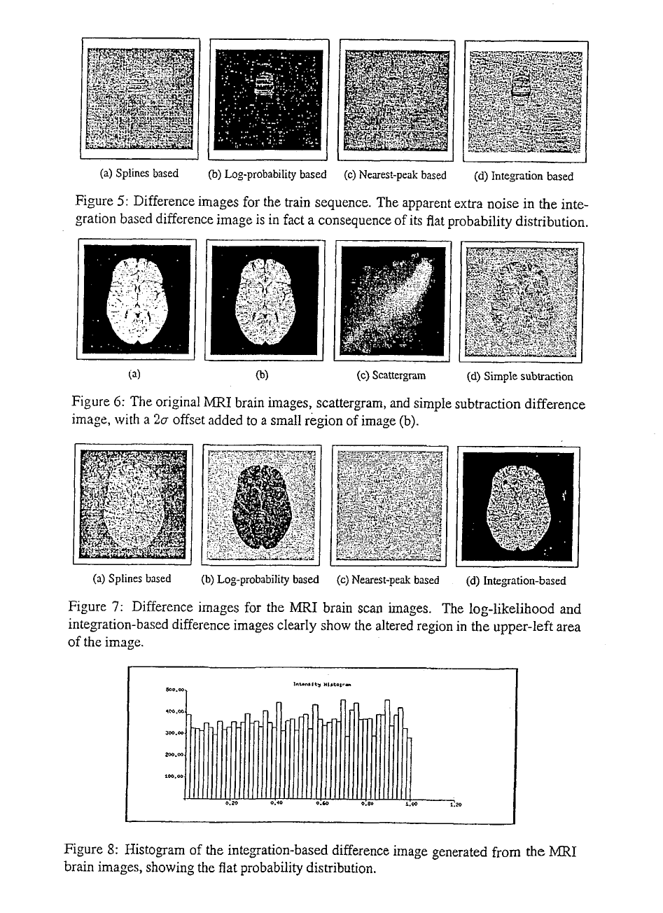

FIG. 5 is four difference images generated using the invention;

FIG. 6 is first and second images of a brain, and a scattergram and difference image generated using a prior art method;

FIG. 7 is four difference images generated using the invention; and

FIG. 8 is a histogram generated using the invention.

A difference image is generated using a scattergram generated from a comparison of data from two images.

In order to construct the scattergram S(g₁, g₂) from the two images, corresponding pixels are found in the two images (i.e. pairs of pixels located at the same coordinates). The grey levels g₁, g₂ of the pairs of pixels are used to define coordinates for entries in the scattergram.

The scattergram is an intensity plot. A region of zero intensity in the scattergram will indicate that the two images do not contain corresponding pixels with grey levels defined by the coordinates of that region. Similarly, a region of high intensity in the scattergram will indicate that the two images contain many corresponding pixels with grey levels defined by the coordinates of that region.

The two images used to generate the scattergram are referred to hereafter as first and second images. The first image grey levels are plotted on the ordinate of the scattergram, and the second image grey levels on the abscissa. This means that any vertical cut on the scattergram F(g₁=const, g₂) isolates a set of pixels in the first image which all have the same grey level. The intensity distribution along this cut gives the relative frequency distribution of grey levels for pixels in the second image. It will be appreciated that the ordinate and abscissa may be exchanged such that the first image grey levels are plotted on the abscissa and the second image grey levels are plotted on the ordinate. This will not materially affect image difference generation.

The scattergram is smoothed using iterative tangential smoothing, to ensure that the surface in grey-level space is smooth and continuous. Tangential smoothing applies local averaging of three grey level values lying on tangents to the local direction of maximum gradient in the scattergram. By definition there should be no change in the tangential direction, other than that due to noise, for a two-dimensional data set. Tangential smoothing therefore smooths the surface in grey-level space in a way that preserves the original data distribution.

Other suitable smoothing methods may be used. For example, the scattergram may be smoothed using a Gaussian function of width equal to the standard deviation of the noise in the first and second images. However, Gaussian smoothing tends to increase the overall size of features in grey level space, an effect that is detrimental to the performance of the difference image generation methods described below.

For similar images, a ridge in the scattergram is effectively a model describing global variations between the two images. For instance, if the level of illumination in the second image were to be increased, the ridge would move upwards in the scattergram. The ridge may therefore be used to differentiate global changes between the first and second images (for example caused by illumination changes) from local changes between the first and second images (for example caused by motion).

Four methods of generating a difference image using the scattergram are set out below. FIG. 1 shows a schematic diagram of the new difference image generation methods.

The first method of generating a difference image using a scattergram involves extracting the position of a ridge in the scattergram by fitting the ridge over a series of ranges with polynomials. Cubic splines are used to guarantee that the curve is smooth and continuous at the boundaries between the ranges. The splines are fitted to a series of knot points on the ridge. Initial approximations for these knot points are chosen by specifying the number of points n desired, dividing the graph into n−1 ranges in the horizontal direction, and searching along boundaries of the ranges in the vertical direction to find maximum values. Any suitable method of polynomial fitting may be used instead of cubic splines (for example B-splines). Similarly, any curve fit may be used (for example linear or quadratic fit).

Once the initial approximations to the knot points have been found, simplex minimisation is used to optimise the fit [W. H. Press, S. A. Teukolsky, W. T. Vetterling and B. P. Flannery, Numerical Recipes in C 2nd Ed., Cambridge University Press, 1992]. A simplex is the simplest geometrical figure in a given number of dimensions that spans all of those dimensions e.g. a triangle in two dimensions. The simplex minimisation technique constructs a simplex figure and applies a basic set of translations and scalings to individual vertices to move them around through a given n-dimensional space. These operations continue until the simplex figure brackets a local minimum of some cost function defined in the space. After each translation or scaling, the cost function is calculated at the new vertex position in order to decide which translation/scaling operation to apply at the next step, and which vertex to apply it to. The technique is applied to each knot point in turn to produce a new set of optimised knot points.

The initial size of the simplex is set to 10 pixels, an arbitrary choice based on the typical size of features in the scattergram. The cost function for the spline fit is defined as the negative sum of the grey levels of the pixels i lying under the spline curve

$$C ( {g}_{1} , {g}_{2}^{max} )$$

in the scattergram.

$$Cost = - {\sum }_{i} F ( {g}_{i} , C ( {g}_{i} {g}_{2}^{max} ) )$$

Once the spline fit has been optimised, it is used to produce a new version of the first image. The grey levels of pixels from the first image are used to define x-coordinates on the scattergram, and the corresponding vertical ordinates for the ridge in the scattergram are found using the spline curves. The vertical ordinates are then used as grey levels in a new image, which can then be subtracted from the second image to give a difference image.

$${D}_{1} ( x , y ) = {I}_{2} ( x , y ) - C ( {I}_{1} ( x , y ) , {g}_{2}^{max} )$$

The new image is effectively a copy of the first image, scaled to remove global changes between the first and second images, as encoded in the ridge in the scattergram. The subtraction of the new image from the second image therefore provides a difference image in which the global mapping has been removed.

A disadvantage of the splines-based method of generating the difference image is that modelling of the ridge in the scattergram will suffer from inaccuracies.

The splines-based method suffers from the further disadvantage that it does not provide statistical information regarding the difference image. Where statistical information is required it must be calculated, for example using Monte Carlo statistics.

The second method of calculating the difference image is termed the log-likelihood method. The log-likelihood method does not rely on fitting curves or finding maxima in the scattergram.

The log-likelihood method comprises normalising a profile of the scattergram along a vertical cut g₁=k to obtain a probability distribution. Where this is done, each graph pixel of the normalised scattergram corresponds to the probability of obtaining a particular grey level value at a pixel in the second image, given the grey level value of the same pixel in the first image.

A difference image may be produced by taking corresponding pairs of pixel grey levels, and producing an image in which pixels are shown with grey levels given by −2 times the natural log of the scattergram probability values:

$${D}_{2} ( x , y ) = - 2 ln [ \frac{F ( {I}_{1} ( x , y ) , {I}_{2} ( x , y ) )}{{\sum }_{c} F ( {I}_{1} ( x , y ) , c )} ]$$

A pixel with a low grey level will represent a low probability of local change between images, whereas a pixel with high grey level will represent a high probability of local change between images.

Assuming that the probability distribution takes the form of a Gaussian,

$$P ( x ; μ , σ ) = \frac{1}{σ \sqrt{2 π}} {ⅇ}^{\frac{- {( x - μ )}^{2}}{2 {σ}^{2}}}$$

where P is the probability of obtaining a measurement x from a Gaussian distribution of mean μ and width σ, then the −2lnP is given by

$$- 2 ln P = 2 ln σ \sqrt{2 π} + \frac{{( x - μ )}^{2}}{ {σ}^{2}}$$

Comparing this to the standard form for a z-score,

$$z = \frac{( x - μ )}{ σ}$$

it can be seen that the right-hand side of the equation for −2lnP, ignoring the first term, is equivalent to the square of the z-score. The log-likelihood method is advantageous when compared to a z-score, because the scattergram will model any arbitrary distribution, not just a Gaussian distribution, including a distribution with arbitrary width.

The difference image obtained using the log-likelihood method, when summed, gives an overall difference statistic. This difference statistic is directly equivalent to a mutual entropy measure, typically used for image co-registration. It might be expected that the returned values can be of use in terms of arriving at sensible statistical decisions regarding the level of difference between two images. Unfortunately, this is only the case when the spread of measured values is the same for all mean values. Another statistic may therefore be required in order to make statistical decisions regarding individual pixels of the difference image.

The third method of calculating the difference image is termed Local Maxima. In some cases, pairs of images may include ambiguous grey level regions. This may manifest itself as bimodal distributions within the scattergram. One way to deal with this is to determine image difference not using a global maxima along a cut, but from a nearest local maxima.

In order to calculate a z-score with reference to the nearest local maximum, the peaks in the scattergram are located by a simple search. The grey levels for a pair of corresponding pixels in the first and second images define coordinates in the scattergram that act as the starting point for the search. The search then proceeds both upwards and downwards in F(g₁,g₂). A peak is roughly located, and then the position is refined by interpolation using a quadratic fit to the three points around the peak. This gives the vertical ordinate g_{cpeak} of the nearest peak in the scattergram, which is subtracted from the vertical ordinate of the starting position to give an effective z-score.

The difference image can be defined as

D₃(x,y)=I₂(x,y)−g_{cpeak}

The z-score is used as the grey level in the difference image, and the procedure is repeated for every pair of pixels from the original images.

The Local Maxima method is most suited to generating a difference image using a scattergram having a bimodal form.

The fourth method of calculating the difference image is termed the probability integration method. This method uses probability distributions in the scattergram directly, without calculating an effective z-score. The method constructs a probability value that represents how likely each grey level is to have been drawn from the same generation process as the rest of the data. In other words, a low probability value indicates a local change between the first and second images.

A vertical cut in a normalised scattergram gives a probability distribution describing the grey levels of a set of pixels in the second image that all have the same grey level in the first image. The grey levels of a pair of corresponding pixels from the first and second images are used to define a set of coordinates in the scattergram. An integration is then performed along the vertical cut passing through this point, summing all of the grey level values smaller than that of this pixel. This total:

$${D}_{4} ( x , y ) = {\sum }_{c} δ ( F ( x , c ) > F ( x , y ) ) F ( x , c )$$

is used as the grey level value for the relevant pixel in the difference image (δ represents the Kronecker delta function).

This technique produces a difference image in which the grey level of each pixel is the probability of the pairing of grey levels for the corresponding pixels in the first and second images.

The distribution of grey levels in the difference image is by definition flat. Such probability distributions are honest [A. P. Dawid, Probability Forecasting, Encyclopaedia of Statistical Science, 7, Wiley, 210-218, 1986], i.e. a 1% probability (a grey level of 1/100^{th}) implies that data will be generated worse than this only 1/100 th of the time. In other words, a pixel in the difference image that has a grey level of 1/100ₜₕ is very likely to represent a ‘real’ local difference between the first and second images.

The probability measure provided by the fourth method according to the invention has the same interpretation as the conventional “chi-squared probability”, except that a particular distribution does not need to be specified. This measure is therefore essentially non-parametric. Low probabilities indicate that the pairing of pixels are uncommon. This is exactly the type of measure that is needed in order to identify outlying combinations of pixel values in an automatic manner, solving the problems inherent in the likelihood based approach.

In some instances it may be beneficial to generate a scattergram using only a selected area of a pair of images, to exclude an unwanted area of a pair of images from scattergram generation. For example, it is generally known that for patients suffering from Multiple Sclerosis lesions are generally found in an upper region of a brain ventricle. A lower region of a pair of images of a brain ventricle may be used to generate a scattergram, so that the statistics provided by the scattergram are not affected by lesions.

The difference image may be combined to determine an overall difference statistic. A low sum will indicate that there are well defined local changes between the first and second images, whereas a high sum will indicate that there are few local changes between the first and second image.

A threshold intensity value may be defined, and a new difference image determined which shows only those areas of the difference image which have an intensity value below that threshold.

The distribution of grey levels in the difference images produced using the fourth method can act as a self-test: ignoring the low probability pixels generated by localised differences, it should be flat. Any significant departure from a flat distribution therefore dictates inappropriate behaviour of the two data sets and therefore unsuitability of the statistic for that comparison.

The four methods described above were tested using synthetic data to ensure that they work as predicted. The methods are designed to be able to ignore effects such as changes in the shading or illumination of features, and focus only on movement of features between images. Two test images are prepared using the image creation tool in TINA [N.A.Thacker, A.Lacey, E.Vokurka, X.P.Zhu , K.L.Li and A.Jackson,

“TINA an Image Analysis and Computer Vision Application for Medical Imaging Research. Proc. ECR, s566, Vienna, 1999]. Each test image is an 8bpp greyscale image, 256 by 256 pixels in size, of a 128 by 128 pixel rectangle in the centre of the frame. The rectangles are shaded so that their grey levels vary smoothly between 30 on one vertical edge and 200 on the other, with the shading being uniform in the vertical direction. The direction of shading is reversed between the two images. Finally, Gaussian noise with a standard deviation of 10 grey levels is added to both images. The resultant test images are shown in FIG. 2. The scattergram and the results of a simple pixel-by-pixel subtraction are also shown in FIG. 2.

It was anticipated that the image difference generation methods described above, should be capable of detecting that the rectangle did not move between the two images, despite the difference in shading, and return difference images containing uniform random noise. The difference images produced by the four methods are shown in FIG. 3.

The splines-based method shows the greatest departure from the expected results, and this is due to a failure in the spline fitting. The fit is good for the peak close to (0,0), which corresponds to the background, and close to the central part of the scattergram. However, it fails in the regions corresponding to the highest and lowest grey level values in the rectangle in the first image. Therefore, the difference image departs from the expected output around the vertical edges of the rectangle.

The difference images generated by the remaining three methods all closely match the expected output. The vertical features at the vertical edges of the rectangles correspond to a slight difference in the positioning of the rectangle between the two frames and, in that respect, show the capability of these methods for detecting movement of image features whilst ignoring other effects. The difference image returned by the probability integration technique has a flat probability distribution and so appears noisier than the other difference images. This is in fact an advantage of the technique, since it allows subsequent quantitative processing of the difference image.

In order to convincingly demonstrate the ability of these methods to detect movement in images, they were applied to a pair of images from a sequence showing a moving train. The original images are shown in FIG. 4, together with the scattergram and the results of a conventional image subtraction. The four difference images generated using the new methods are shown in FIG. 5.

The images of the train were chosen because of their simplicity, and they include none of the common undesirable effects, such as global illumination changes, that the method according to the invention is designed to cope with. For this reason, the embodiments of the invention show little improvement in performance over simple image subtraction. However, the images shown in FIG. 5 do demonstrate that the embodiments of the invention are capable of identifying changes in images due to motion within a scene: in each case the boundaries of the train are identified. The tracks and the ruler next to them are also detected to varying extents, since the point of focus shifted as the train moved towards the camera. The consequent changes in the degree of blurring at any given point on these features are greatest close to the point of focus (the front of the train) and so these changes are localised and are detected by the new methods. The region of the ruler closest to the camera is also saturated in both of the original images, suppressing the noise. This is highlighted by the probability integration technique.

The image difference generation methods described above may be applied to medical image data. For example, multiple sclerosis (MS) lesions in the brain can be hard to detect in an magnetic resonance imaging (MRI) scan. Lesions may be highlighted using an injection of gadolinium (GdDTPA), which concentrates at the lesion sites. Scans taken before and after the injection can be subtracted to highlight the lesions. However, the gadolinium also alters the global characteristics of the scan, so that a simple pixel-by-pixel image subtraction will not remove all of the underlying structure of the brain from the image. The above described image difference generation methods are able to take the global changes into account, and thus produce an image which shows only the lesions.

In order to test the image difference generation methods, simulate this process, two T2 scans with slightly different echo train times (TE) of the same slice of a brain were used. The background in these images was found to have approximately the same grey level value as the white matter in the brain, and therefore formed the dominant peak in the scattergram at that grey level. This had a detrimental effect on the operation of the difference generation methods, and so the background was removed from the images. An offset too small to be detected visually was added to a small circular region of one of the brain images, and the differencing routines were applied in an attempt to detect the change. The magnitude of the offset was based on the noise in the original images, calculated from the width of vertical and horizontal gradient histograms of the original images around zero.

FIG. 6 shows the brain images with an offset of 2σ added to a small region of one image, together with the scattergram and the results of a simple subtraction. The altered region cannot easily be detected visually in the original images, and is barely visible in the pixel-by-pixel difference image FIG. 6d.

FIG. 7 shows the difference images generated using the methods described above. The altered region shows up clearly in the output from the log-probability and integration-based methods. The altered region ceases to be detectable when the magnitude of the offset is reduced below around 1σ.

The capabilities of the log-probability and integration-based methods are clearly demonstrated using the synthetic data. The images of the moving train were chosen for their simplicity, and did not exhibit any of the undesirable effects that the new techniques are designed to avoid, so there is little improvement over simple subtraction for these images. However,-when the train images and brain images are considered together, it is clear that the new techniques are superior for motion detection in more complex and realistic environments. The methods are also shown to be superior in detecting abnormalities in medical images, demonstrating the wide range of potential applications.

The log probability and integration based methods may be considered as the definitions of new non-parametric statistical tests, with theoretically predictable properties. Furthermore, the integration based method is capable of self-test. The self-test capability is illustrated in FIG. 8 which shows a histogram of the integration based difference image generated using the brain images. The histogram has a flat probability distribution, indicating that the data behaves correctly.

One of the most important features of the log probability and integration based methods is that the grey levels in the difference images corresponded to well-defined quantities: the square of the z-score and a probability respectively. The fact that the grey levels have well defined statistical values allows further analysis of the image, for example using thresholding, regional analysis or other techniques. This is in sharp contrast to pixel-by-pixel image subtraction, where the grey levels in the difference image are arbitrary measures of difference in units of grey levels, and have no objective meaning.

1. A method of generating a difference image based upon a comparison of two input images, the method comprising generating a scattergram representing correspondence between intensity values of areas in the first image and intensity values of areas in the second image, and using characteristics of the scattergram to generate a difference image in which the effect of a global change between the first and second input images is reduced.

2. A method according to claim 1, wherein a cut through the scattergram which corresponds to areas of the first or second images having a particular intensity value or range of intensity values is normalised, intensity values of a pair of corresponding areas in the first and second images are used to define coordinates of an area in the scattergram which lies within the cut, an integration is performed along the cut, the integration summing all intensity values less than the intensity value of the defined area in the scattergram, and the result of the integration is used to determine an intensity value for a corresponding area in the difference image.

3. A method according to claim 2, wherein the result of the integration is used directly as the intensity value for the corresponding pixel in the difference image.

4. A method according to claim 2 or claim 3, wherein the difference image is combined to determine an overall difference statistic.

5. A method according to any of claims 2 to 4, wherein a threshold intensity value is defined and a new difference image is determined which shows only those areas of the difference image which have an intensity value below that threshold.

6. A method according to any of claims 2 to 5, wherein the scattergram is generated using a pre-selected region of the first and second images in which local variations between the images are expected to be minimal.

7. A method according to claim 1, wherein a ridge indicative of similarities between the first and second images is located in the scattergram.

8. A method according to claim 7, wherein an intensity value of a given area in the first image or second image is used to define an intensity value on a first axis of the scattergram, a corresponding intensity value on a second axis of the scattergram is determined using the ridge, and this intensity value is used to define the intensity value of an area in a new image which is subtracted from the first image or second image to generate the difference image

9. A method according to claim 7 or claim 8, wherein the ridge is located using cubic splines.

10. A method according to claim 9, wherein the cubic splines are fitted to knot points on the ridge using simplex minimisation.

11. A method according to claim 1, wherein normalisation is performed along a cut in the scattergram which corresponds to areas having a single intensity value in the first image or second image, thereby providing a probability distribution, the intensity values of a pair of corresponding areas in the first and second images are used to define coordinates of an area in the scattergram, and the intensity value of a corresponding area in the difference image is determined using a function which increases as the probability decreases.

12. A method according to claim 11, wherein the function is a natural logarithm.

13. A method according to claim 12, wherein the intensity of the corresponding area in the difference image is −2 times the natural logarithm of the normalised intensity of the area in the scattergram.

14. A method according to any of claims 11 to 13, wherein the difference image is summed to determine an overall difference statistic.

15. A method according to claim 1, wherein a pair of corresponding areas in the first and second images are used to define coordinates of an area in the scattergram, the location of a nearest local maximum is determined by comparing intensity values along a cut which corresponds to areas having a single intensity value in the first image or second image, and a z-score is calculated based upon a distance between the defined area in the scattergram and the local maximum.

16. A method according to claim 15, wherein the z-score is used as an intensity value in the difference image.

17. A method according to claim 15 or claim 16, wherein the probability that an area in the difference image represents a local difference between the first and second images is determined from the square of the intensity value of that area in the difference image.

18. A method according to any preceding claim, wherein the areas are pixels

19. A method according to any preceding claim, wherein the intensity values are grey level values.

20. A method according to any preceding claim, wherein the scattergram is smoothed.

21. A method according to claim 20, wherein the scattergram is smoothed using iterative tangential smoothing..

22. A method substantially as hereinbefore described with reference to the accompanying figures.
